(19) United States
(12) Patent Application Publication
(10) Pub. No.: US 2002/0103854 A1
(43) Pub. Date: Aug. 1, 2002

(54) Personal data management apparatus and personal data management method

(75) Inventor: Fujio Okita, Tokyo (JP)

Correspondence Address: Charles H. DeVoe, Kolisch, Hartwell, Dickinson, McCormack & Heuser, 520 S.W. Yamhill Street, Suite 200, Portland, OR, 97204, US

(73) Assignee: Landscape Company, Limited.

(21) Appl. No.: 09/771,305

(22) Filed: Jan. 26, 2001

(51) Int. Cl. G06F 17/30; G06F 7/00; G06F 15/16

(52) U.S. Cl. 709/203; 707/10

(57) ABSTRACT

An identification code for each customer is printed on a mailing label of direct mail beforehand. After a telephone set control section (9) connects an incoming call from a customer at the other end of a telephone line (5a) to a telephone set (5), a voice recorder control section drives a voice recorder to play a message guiding the customer to refer to the mailing label and prompting the input of the identification code assigned to the customer. The identification code received by the telephone set (5) is stored in a reception code memory (15) and the personal data record corresponding to the identification code is deleted from customer database memory (19) after a code control judgment section (16) checks whether the input code has already been stored in the reception code memory (15). When a command for outputting a new set of mailing labels is input from a keyboard (3), a printer control section (20) passes the personal data records in the customer database memory (19) to a printer (21). Such automatic manipulation by the personal data management apparatus reduces the labor and time required for the maintenance of personal data and prevents further direct mail from being delivered to the customer.

### BACKGROUND OF THE INVENTION

1. Field of the Invention

The present invention relates to a personal data management apparatus that manages personal data including addresses, names, phone numbers, etc., and is used for marketing purposes such as direct mail, phone marketing, or the like.

This application is based on patent application No. Hei 10-259325 filed in Japan, the contents of which are incorporated herein by reference.

2. Description of the Related Art

Conventionally, a dealer who needs to send direct mail to many customers or needs to carry out marketing activities on the telephone maintains a database containing personal data of the customers and uses lists of the personal data retrieved from the database for the submission of the direct mail or the telephone calls. However, some customers do not wish to receive such direct mail or telephone calls and request the dealer to delete their personal records from the database. It is also desirable from the point of view of privacy protection to support the data entity's (customer's) right to delete his/her records.

Conventionally, when a customer calls the dealer and requests that the customer's personal data be deleted from the database, the dealer's receptionist usually responds to such telephone calls one at a line, searches the database for the record of the customer, and deletes it. Such a way of managing the personal database requires a great deal of labor and time, and is therefore inconvenient.

### SUMMARY OF THE INVENTION

Therefore, an object of the present invention is to provide a personal data management apparatus with which personal data can be managed to fulfill the wishes of the customers, to which the data corresponds, and save labor and time.

According to the present invention, the object has been achieved in a personal data management apparatus, which manages the personal data of multiple individuals using a database file containing multiple personal data records corresponding to said individuals with identification codes for identification of said personal data records, comprising: a database file storage section which is capable of containing the database file; a communication control section which transmits and receives signals via a communication circuit; a guidance message control section which stores multiple guidance messages, which makes a selection from the stored multiple guidance messages in response to a signal received by the communication control section, and which passes the selected message as a signal for transmission to the communication control section; and, a data processing section which executes prescribed processes, based on an identification code received as said signal from the communication control section.

Such a personal data management apparatus enables an individual, to which the personal data corresponds, to perform the desired processes on the personal data corresponding to the individual in the database file by ringing up to access to the personal data management apparatus of the present invention via a communication circuit, and by sending an identification code and other information in response to guidance messages which are output selectively. Thus, the processing of the personal data can be done automatically in the personal data management apparatus by the manipulation by the individual, and this process does not require labors such as that by receptionists to receive telephone calls as in conventional method, and the time for this process will be shortened. To sum up, as an effect of the present invention, the labor and time required for the management of in compliance with the wishes of the individuals to which the data corresponds is reduced.

Also, according to the present invention, the object has been achieved in a personal data management method comprising steps of: storing beforehand personal data records, each of which contains a unique identification code, in a database; establishing a communication connection; outputting a guidance message via the established communication connection for prompting the input of an identification code; receiving the identification code sent via the established communication connection; storing the received identification code into a reception code memory; and, outputting only the personal data records whose identification codes are not included in said reception code memory.

### BRIEF DESCRIPTION OF THE DRAWINGS

FIG. 1 is a block diagram to show a personal data management apparatus, an embodiment of the present invention.

FIG. 2 shows a table of examples of recorded guidance voice messages.

FIG. 3 is a flowchart to show the processes followed in a data management computer program.

FIG. 4 is a conceptual illustration to show the customer database file.

FIG. 5 is an illustration to show the front face of an envelope for direct mail.

### DESCRIPTION OF THE PREFERRED EMBODIMENTS

The following embodiments do not restrict the interpretation of the claims relating to the present invention, and the combination of all the features explained in the embodiments is not always an indispensable means of solving the problem.

In the following, preferred embodiment of the present invention will be explained in detail with reference to the drawings.

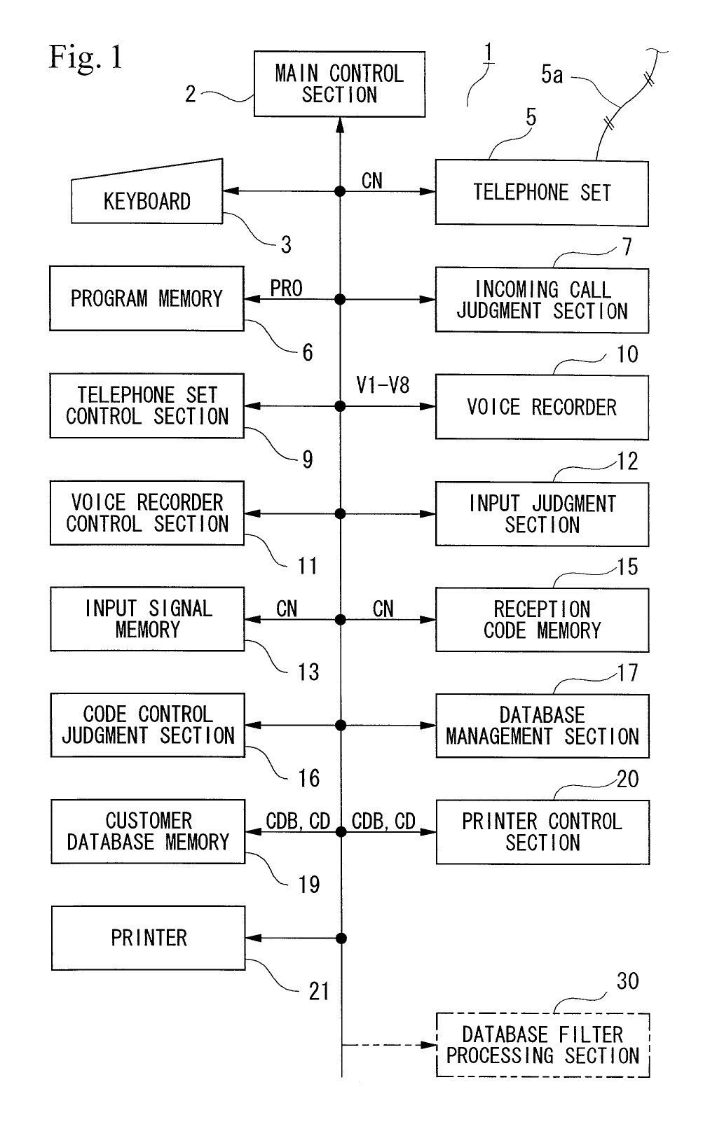

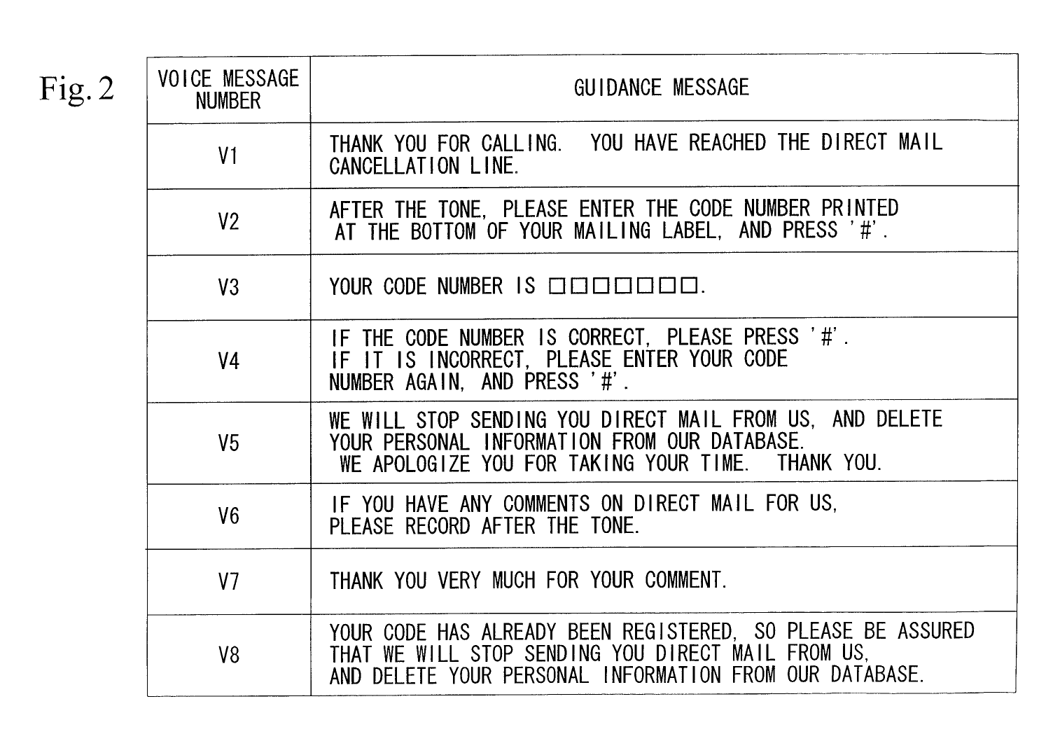

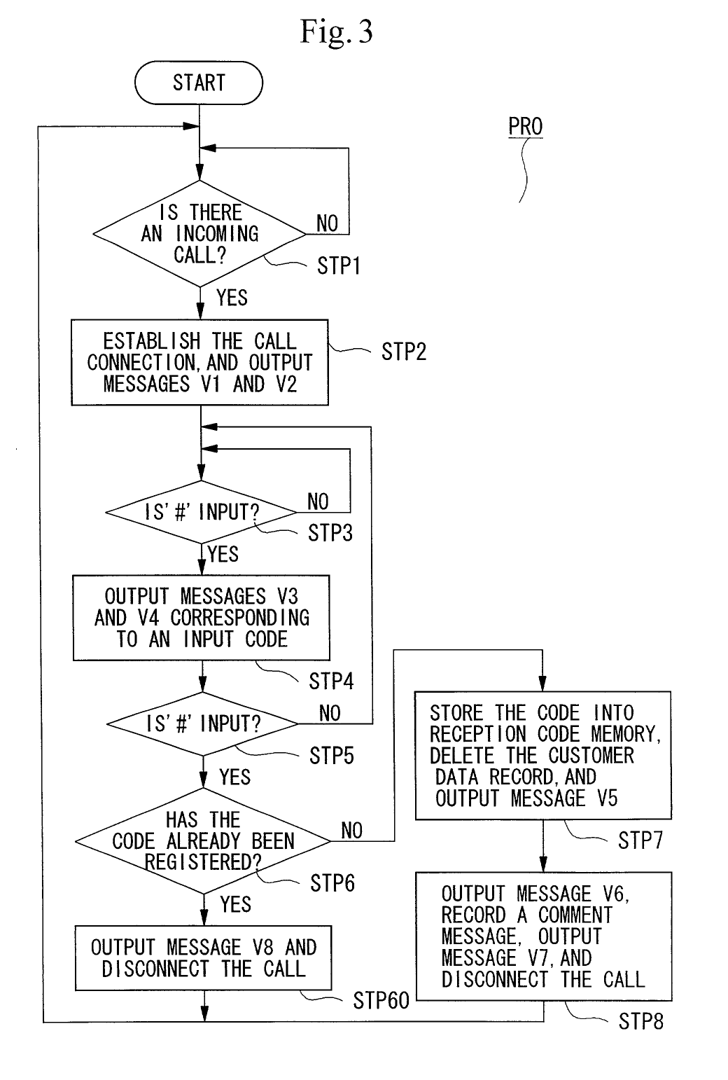

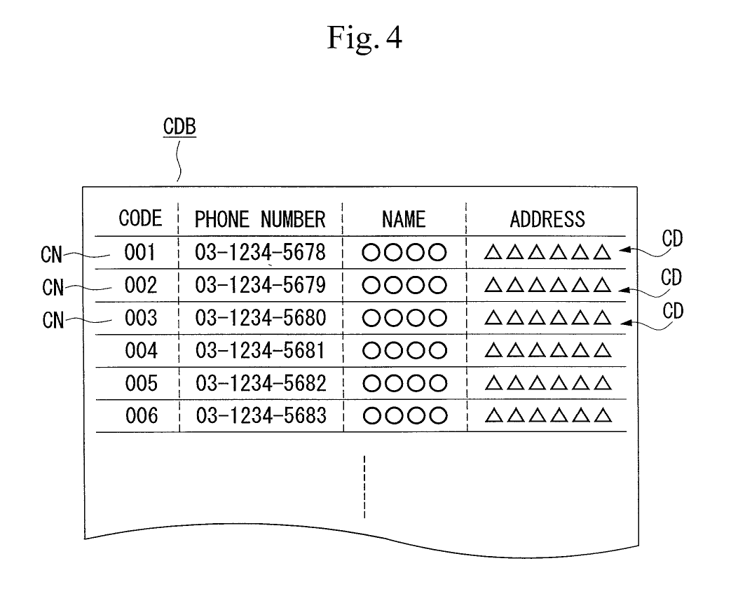

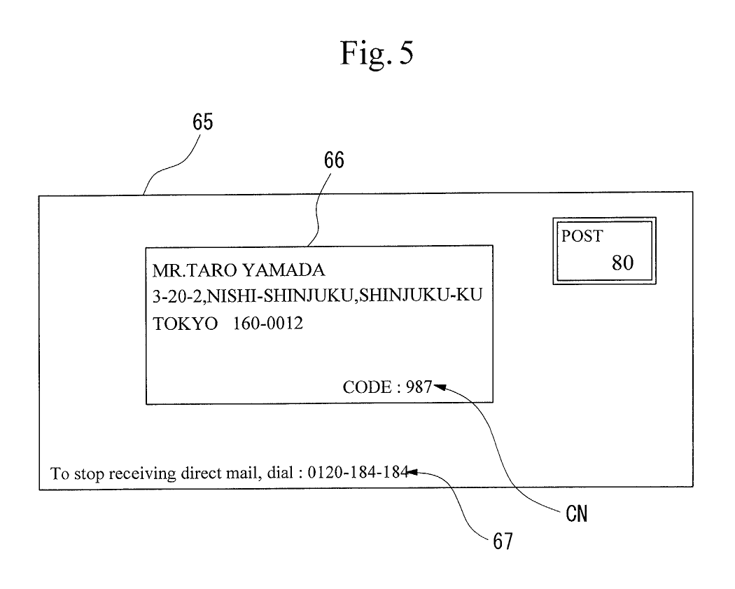

FIG. 1 is a block diagram to show a personal data management apparatus, an embodiment of the present invention; FIG. 2 shows a table of examples of recorded guidance voice messages; FIG. 3 is a flowchart to show the processes followed by a data management computer program; FIG. 4 is a conceptual illustration to show the customer database file; and FIG. 5 is a illustration to show the front face of an envelope for direct mail.

The personal data management apparatus 1, which is an embodiment of the present invention, is implemented to provide a function for automated reception of Mail Preference Service (MPS), and contains a main control section 2 as shown in FIG. 1. The main control section 2 is connected through a bus line to keyboard 3, a telephone set 5, program memory 6, an incoming call judgment section 7, a telephone set control section 9, a voice recorder 10, a voice recorder control section 11, an input judgment section 12, input signal memory 13, reception code memory 15, a code control judgment section 16, a database management section 17, customer database memory 19, a printer control section 20, a printer 21, and so on, and a data management program PRO is stored in the program memory 6.

The voice recorder 10 uses publicly known technologies and comprises a guidance replaying apparatus and a message recording apparatus. The guidance replaying apparatus is capable of making a selection from guidance messages V1 to V8 recorded and saved beforehand, replaying the selected message, and outputting it to the telephone set 5. The message recording apparatus is capable of recording a voice message from the other party of a phone call input through the telephone set 5. An operator of the voice recorder 10 can replay the message recorded by the message recording apparatus at any time. FIG. 2 shows examples of the voice messages V1 to V8 recorded and stored beforehand at the guidance replaying apparatus of the voice recorder 10. In FIG. 2, each of voice numbers V1 to V8 corresponds to a message.

The customer database memory 19 contains a customer database file CDB such as shown in FIG. 3. The customer database file CDB contains many customer data records CD. Each customer data record CD holds the personal data of a customer and includes the customer's telephone number, name, address, and the like. A code CN is a serial number like 001, 002, 003, and so on, and is attached to each customer data record CD, so that each customer data record can be identified by the code CN. Furthermore, it is possible for a customer data record to include such data items as shopping history or an income amount for example. The customer database memory 19 could be a built-in hard disk drive or a removable disk such as a floppy disk, a magnetic optical (MO) disk, or the like.

The personal data management apparatus 1 is configured as described above, so this apparatus manages personal data records (customer data records CD) as follows. First, when the personal data management apparatus 1 is activated, the main control section 2 reads the data management program PRO from the program memory 6, and from this time on executes the processes shown in FIG. 2 according to the data management program PRO. That is to say, the main control section 2 makes the incoming call judgment section 7 judge whether there is an incoming call signal at the telephone set 5 (step STP1 in FIG. 3). When a customer has received direct mail as shown in FIG. 5 and the customer wishes to delete his/her own personal record (customer data record) from the database for rejecting such direct mail, the customer dials up the phone number 67 of “DM Rejection Dial” printed on the envelope 65. This phone number 67 is the number for calling the telephone set 5 of the personal data management apparatus 1, but it is not required for the phone number 67 to be shown on the envelope 65.

When an incoming call signal from the customer arrives at the telephone set 5, the incoming call judgment section 7 outputs judgment result to the telephone set 5. In response to the judgment result, the telephone set control section 9 establishes a connection. Simultaneously, in response to the judgment result from the incoming call judgment section 7, thus in response to the incoming call signal described above, the voice recorder control section 11 drives the voice recorder 10 to replay the guidance messages V1 and V2 (refer to FIG. 2) stored in the voice recorder 10 and to send them out through the telephone set 5 (step STP2 in FIG. 3). The customer at the other end listens to the messages V1 and V2 and inputs the code CN printed at the bottom of the mailing label 66 (refer to FIG. 5) with push buttons and then pushes ‘#’, which represents a terminating signal. This terminating signal is not necessarily ‘#’, and may be ‘*’ or the like. This mailing label 66 was printed out using the name, the address, and the code stored in the customer record CD in the customer database file CDB. The code CN at the bottom of the mailing label 66 identifies this record in the customer database file CDB.

On the other hand, after the process of step STP2 shown in FIG. 2 finishes, the input judgment section 12 continues to judge whether the terminating signal (the signal sent by the ‘#’ button) is input by the other party through the telephone set 5 (step STP3 in FIG. 3) while signals by the other party's input are passed from the telephone set 5 through the telephone set control section 9 to be stored in the input signal memory 13. As described before, the customer at the other end pushes the buttons to input code CN and ‘#’ at the end, so the code CN will be stored in the input signal memory 13 and the input judgment section detects the terminating signal from the other party. Based on this detection by the input judgment section 12, the voice recorder control section 11 drives the voice recorder 10 to replay the guidance messages V3 and V4 (refer to FIG. 2) stored in the voice recorder 10 and to send them out through the telephone set 5 (step STP2 in FIG. 4). Before the voice recorder control section outputs here the message V3, the voice recorder 11 reads the code CN that has been stored in the input signal memory 13, and inserts the code number CN as voice into the message V3.

Then, the customer at the other end listens to the guidance messages V3 and V4, and confirms the number inserted in the message V3 from the code CN on the mailing label 66 of the direct mail (refer to FIG. 5). If the number in the message V3 and the code CN on the mailing label 66 are identical, the customer inputs a confirmation signal by pushing the ‘#’ button. This confirmation signal is not necessarily ‘#’, and may be ‘*’ or the like. By the way, the input judgment section 12 continues to judge whether the confirmation signal (the signal caused by ‘#’) is input at the other end (step STP5 in FIG. 3) after the process of step STP4 in FIG. 3 finishes. So, when the customer pushes the ‘#’ button, the input judgment section 12 detects the confirmation signal and the control proceeds to the next step, STP6. If the number in the message V3 is different from the code CN on the mailing label 66, the customer inputs the code CN again following the message V4. In this case, the input signal from the other end via the telephone set 5 is representing the code CN, which is not a confirmation signal (a signal caused by ‘#’), so the input judgment section 12 judges that there is no confirmation signal at step STP5 in FIG. 3 and the control will return to step STP3 again. Then, the input code CN and a following ‘#’ are detected, which makes the control proceed to step STP3, then STP4, as described before. The steps STP3 to STP5 are repeated any number of times until the correct code CN is input and confirmed by the customer. Once the correct code CN is confirmed, the control will move to the next step, STP6.

By the way, when the customer inputs a code CN to the personal data management apparatus 1, this code CN is stored in the reception code memory 15 at step STP7 as mentioned later. And the reception code memory 15 contains all the codes CN which the personal data management apparatus 1 has accepted up to the present moment. At step STP6, the code control judgment section 16 retrieves from the input signal memory 13 the code CN that was input right before the detection of the confirmation signal at step STP5, compares this code CN with all the codes CN stored in the reception code memory 15, and judges whether the code CN retrieved from the input signal memory 13 has already been stored in the reception code memory 15. That is, the code control judgment section 16 judges whether the code CN retrieved from the input signal memory 13 has already been accepted by the personal data management apparatus 1.

At the step STP6 mentioned above, if the code CN retrieved from the input signal memory 13 turns out to be one of the codes already accepted, which means that the customer at the other end has already been registered at “DM Rejection Dial” but is trying again, the voice recorder control section 11 drives the voice recorder 10 to replay the guidance message V8 (refer to FIG. 2) stored in the voice recorder 10 and to send it out through the telephone set 5, and the telephone set control section 9 disconnects the line for the telephone set 5 (step STP60 in FIG. 3). In this case, because the customer's code CN has already been accepted and thus the customer data record CD with this code CN has already been deleted, it is not necessary to delete the customer data record CD. After the process of step STP60, the control will be returned to the above-mentioned step STP1.

At the step STP6, on the contrary, if the code CN retrieved from the input signal memory 13 turns out to be one that has not been accepted, which means that the customer at the other end is trying to register to “DM Rejection Dial” for the first time, the control proceeds to step STP7 in FIG. 3. At the step STP7, the code control judgment section 16 stores the code CN which was judged as a new one in the step STP6 to the reception code memory 15, the database management section 17 searches the customer database file CDB in the customer database memory 19 for the customer data record CD according to the code CN judged at step STP6 and deletes this customer data record CD, which contains the personal data of the customer at the other end of the line, and the voice recorder control section 11 drives the voice recorder 10 to replay the guidance message V5 (refer to FIG. 2) stored in the voice recorder 10 and to send it out through the telephone set 5.

After the process of the step STP7 in FIG. 3 finishes, the control proceeds to step STP8. At the step STP8, the voice recorder control section 11 drives the voice recorder 10 to replay the guidance message V6 (refer to FIG. 2) stored in the voice recorder 10 and to send it out through the telephone set 5. And furthermore, the voice recorder control section 11 drives the voice recorder to output a tone signal through the telephone set 5, and turns on the recording apparatus of the voice recorder 10 (refer to message V6 shown in FIG. 2). The customer listens to the message V6 and speaks following the message V6 while the recording apparatus of the voice recorder 10 records the message from the customer through the telephone set 5. After a prescribed length of recording time passes, the voice recorder control section 11 turns off the recording apparatus of the voice recorder 10 (the recording of the customer's message stops at this moment), and drives the voice recorder 10 to send the guidance message V7 out through the telephone set 5. After the output of the message V7 finishes, the telephone set control section 9 disconnects the line for the telephone set 5. After the process of the step STP8, the control will be returned to the above-mentioned step STP1. The customer's message recorded by the recording apparatus of the voice recorder 10 can be replayed at any time by the manipulation of the operator.

From this time on, when an incoming call from another customer arrives, the personal data management apparatus 1 deletes the customer data record CD from the customer database file CDB according to the customer's wish, by repeating the processes of the steps STP1 to STP8 (or STP60). And, after the maintenance process of the personal data is done, if an output list of the customer data records CD or mailing labels 66 as shown in FIG. 5 for sending direct mail is required, the printer control section 20 transmits the data of the customer database file CDB in the customer database memory 19 to the printer 21 and makes the data print, according to a print command input from the keyboard 3. Because the customer data records CD of the customers who wish to delete their personal data have already been deleted, as described before, from the customer database file CDB, the printed output list or the mailing labels do not include the data of such customers. This means that this output list or these mailing labels can be used as they are for sending direct mail, and the customers who do not wish to receive direct mail do not receive direct mail or are not troubled.

As described above, by using the personal data management apparatus 1 of this embodiment, receptionists do not have to handle telephone calls from customers who receive direct mail and wish to delete personal data, and operators need not search the database for a customer record and delete it manually for data maintenance purposes. That is, it is favorable that data management work such as the deletion of personal data can be done automatically and does not require labor or time. And, the personal data can be managed so easily that dealers can promote privacy protection actively, and which is advantageous for dealers, not to mention customers, in terms of improvement of the image of the company, for example. And, as the privacy protection improves, the number of telephone complaints from the customers decreases dramatically, and it reduces the stress and fatigue of receptionists. Furthermore, because the customers can request the deletion of personal data by listening to the guidance message from the voice recorder 10 and by making inputs to the computer system without talking to operators, the procedure for the customers will be simpler and psychologically easier, and privacy protection will be further enhanced.

Though the database management section 17 functions as a data processing section which executes the process of the deletion of the customer data record CD from the customer database file CDB based on the code CN sent from the customer at the other end in the embodiment described above, as another example, it is possible that the personal data management apparatus 1 includes a database filter processing section 30, which is connected to the main control section 2 as shown with a two-dot chain line in FIG. 1, and that the data processing section comprises the reception code memory 15 and the database filter processing section 30. In this case, the process of the deletion of the matched customer data record CD from the customer database file CDB in the customer database memory 19 is not executed at the step STP7 in FIG. 3. Instead, when outputting the list of the customer data records CD for the purpose of sending direct mail, a print command input by an operator with the keyboard 3 makes the database filter processing section 30 read the customer database file CDB from the customer database memory 19 and read all the codes CN stored in the reception code memory 15. Then, the database process section 30 passes the customer database file CDB to the printer control section 20 while excluding the customer data records CD whose customer codes match the codes CN read from the reception code memory 15. In this way, the customer database file CDB passed from the printer control section to the printer 21 for outputting does not include the customer data records with the codes CN that have been registered as rejections. In this case, the customers who do not wish to receive direct mail are not troubled, and besides, the customer database file CDB in the customer database memory 19 is maintained untouched, which is favorable because the dealer does not have to lose any valuable information resources.

Though the customer is connected to the personal data management apparatus by a telephone line in the embodiment described above, the communication circuit is not restricted to a telephone line and could be the Internet, a leased line, or the like. And, though examples of the guidance messages V1 to V8 are shown in FIG. 2, those messages are variable and are not restricted to the ones in FIG. 2. Besides, the messages are not necessarily sent to the customers as voice messages, and could be character messages if the customer side has a display apparatus. And, the communication control means can comprise a modem (or a terminal adapter) and its control means (a driver) or the like for example, in addition to the telephone set 5 and the telephone set control section 9 in the above embodiment. Furthermore, the output means could be a floppy disk or a magnetic optical disk which the database file is written to, and the disk drive apparatus for them, besides the printer control section 20 and the printer 21 in the above embodiment. And, though the management of the customer database for direct mailing is explained as an example in the above embodiment, the personal data management apparatus of the present invention could be applied to the data management of a large number of individuals for various purposes, an example of which is telephone marketing.

As explained, in the present invention, the personal data management apparatus manages multiple personal data using a database file (customer database file CDB) which contains multiple personal records (customer data records CD) including identification codes (code CN), and comprises a database file storage section (customer database memory 19) which is capable of containing the database file, a communication control section (telephone set 5 and telephone set control section 9) which transmits and receives signals via a communication circuit (telephone line 5a), a guidance message control section (voice recorder 10 and voice recorder control section 11) which stores multiple guidance messages (messages V1 to V8), makes a selection from the stored multiple guidance messages in response to a signal received by the communication control section, and passes the selected message(s) as a signal for transmission to the communication control section; and, a data processing section (database management section 17, reception code memory 15, and database filter processing section 30) which executes prescribed processes, based on an identification code received as a signal from the communication control section. Such a configuration enables an individual, to whom the personal data corresponds, to perform the desired processes on the personal data corresponding to the individual in the database file by ringing up to access to the personal data management apparatus of the present invention via a communication circuit, and by sending an identification code and other information in response to guidance messages which are output selectively. Thus, the processing of the personal data can be done automatically in the personal data management apparatus by the manipulation by the individual, and this process does not require labor such as that by a receptionist to receive complaint telephone calls as in conventional way and the time required for this process is reduced. To sum up, as an effect of the present invention, the labor and time required for the management of the personal data in accordance with the wishes of people to whom the data corresponds.

Further, in the present invention, the data processing section of the personal data management apparatus deletes the personal data corresponding to the identification code received by the communication control section, from the database file stored in the database file storage section. In addition to the effect described above, such a configuration makes it possible to delete with certainty the personal data in order to comply with the corresponding individual's wish, and to thoroughly protect the individual's privacy.

Further, in the present invention, the personal data management apparatus comprises an output section (printer control section 20 and printer 21) which is capable of outputting the database file processed by the data processing section in a mailing label format including the identification code of the personal data records. In addition to the effect described above, such a configuration makes it possible to send direct mail based on the output database file. And, it is favorable that direct mail is not sent to the individuals who do not wish to receive it because those individuals are excluded from the output database file which is processed by the data processing section. And, the personal data which is output in the mailing label format includes the identification codes, so that the mailing labels for direct mail mention the identification code. When an individual who has received direct mail wishes to process the corresponding personal data, manipulation is favorably easy and all that is needed for the individual is to access to the personal data management apparatus is to read the identification code on the label, and to input the code.

Further, in the present invention, the data processing section of the personal data management apparatus includes an identification code storage section (reception code memory 15) which stores the identification code received by the communication control section and a transmission blocking section (database filter processing section 30) which prevents only the personal data records corresponding to the identification codes stored in the identification storage section from being transmitted to the output section. In addition to the effects described above, with such a configuration, the processing of the database file is done when the database file is transmitted to the output section, which means it is possible to maintain the database file, stored in the database file storage section untouched, and it is possible to avoid losing valuable information resources. It is favorable to be able to make use of the database file in the database file storage section effectively at another opportunity.

The processes described above may be performed by recording application programs for performing the processes, and loading and executing the programs on a computer system to control communication, send guidance messages, receive signals, and to process data based on the received signals. “Computer system”, in this context, includes any OS (operating system) and peripheral hardware.

Computer-readable recording media include portable media such as floppy disks, opto-magnetic disks, ROM, CD-ROMs, as well as fixed memory devices such as hard disks housed in computer systems. Further, computer-readable recording media include those that hold programs for a given length of time, such as volatile memories (RAM) contained internally in computers for servers and client computer systems used in transmitting application programs through networks such as the Internet or communication lines of telephone circuits.

So far, various embodiments of the present invention have been described with reference to the diagrams, but the specific structures are not limited to those exemplified, and include designs that can be included within a range of the essence of the present invention.

What is claimed is:

1. A personal data management apparatus, which manages the personal data of multiple individuals using a database file containing multiple personal data records corresponding to said individuals with identification codes for identification of said personal data records, comprising:
a database file storage section which is capable of containing the database file;
a communication control section which transmits and receives signals via a communication circuit;
a guidance message control section which stores multiple guidance messages, which makes a selection from the stored multiple guidance messages in response to a signal received by the communication control section, and which passes the selected message as a signal for transmission to the communication control section; and,
a data processing section which executes prescribed processes, based on an identification code received as said signal from the communication control section.

2. A personal data management apparatus according to claim 1, wherein said data processing section deletes the personal data record corresponding to the identification code received by the communication control section from the database file stored in the database file storage section.

3. A personal data management apparatus, according to claim 1, comprising an output section which is capable of outputting the database file processed by the data processing section in a mailing label format including said identification code of said personal data record.

4. A personal data management apparatus according to claim 3, wherein said data processing section comprises:
an identification code storage section which stores the identification code received by the communication control section; and,
a transmission blocking section which prevents only the personal data records corresponding to the identification codes stored in said identification storage section from being transmitted to the output section.

5. A personal data management method comprising the steps of:
storing beforehand personal data records, each of which contains a unique identification code, in a database;
establishing a communication connection;
outputting a guidance message via the established communication connection for prompting the input of an identification code;
receiving the identification code sent via the established communication connection;
storing the received identification code in a reception code memory; and,
outputting only the personal data records whose identification codes are not included in said reception code memory.

6. A personal data management method according to claim 5, comprising the step of deleting the personal data record, whose identification code is identical with the identification code sent via the established communication connection, from said database.

7. A personal data management method according to claim 5, wherein the data records whose identification codes are included in the reception code memory are excluded at the outputting time, by referring to the reception code memory.

8. A personal data management method according to claim 5, wherein the personal data records are output in a mailing label format which includes said identification code.
